(19) United States
(12) Patent Application Publication
(10) Pub. No.: US 2005/0216531 A1
(43) Pub. Date: Sep. 29, 2005

(54) Personal web diary

(76) Inventor: Robert R. Blandford, Alexandria, VA (US)

Correspondence Address: ROBERT PLATT BELL, P.O. BOX 310, AURORA, NY, 13026, US

(21) Appl. No.: 10/807,270

(22) Filed: Mar. 24, 2004

(51) Int. Cl. G06F 17/30

(52) U.S. Cl. 707/204

(57) ABSTRACT

Diary entries may be created and a digital signature be calculated and appended at many locations and, from such locations, transmitted as a diary record to an archive over the Internet or Web. To ensure that user 1 cannot modify or delete a diary entry, once it is sent to archive 3, user 1 and archive 3 enter into an agreement that archive 3 may store the submitted diary records for a fixed period of time, and that archive 3 may not allow anyone, including user 1, to modify or delete these records during this time interval.

### CROSS-REFERENCE TO RELATED APPLICATIONS

The subject matter of the present application is related to that the following Patents issued to the present inventor, all of which are incorporated herein by reference:
U.S. Pat. No. 5,189,700
U.S. Pat. No. 5,347,579
U.S. Pat. No. 6,442,691
U.S. Pat. No. 6,470,449

### FIELD OF THE INVENTION

The present invention relates to computerized diaries. In particular, the present invention is directed toward an on-line method of storing a computer diary in such a manner that it cannot be altered, erased, or deleted, and that it also may be accurately time-stamped.

### BACKGROUND OF THE INVENTION

In the Prior Art, there are descriptions of personal computer diaries or records, which provide the user with the capability to create a diary entry, and to securely digitally sign and time-stamp the record in order to prove that the user created the entry and that it was created at a particular time. In this Prior Art, the record comprising the entry, time-stamp, and digital signature have also been permanently stored, protected by hardware, software, and passwords against being read by persons other than the user, and against modification or erasure by anyone, including the user. This last point is important, because it is one of the desirable properties of a diary that portions of it cannot easily be undetectably altered or destroyed by anyone, even the user.

Examples of such Prior Art personal computer diaries may be found in applicant's issued Patents cited above and incorporated herein by reference in their entirety.

The embodiments of the personal computer diary have heretofore been described in terms of a personal computer, in some embodiments a lap-top computer, with a secure hard drive, encryption means, and an un-resettable real-time clock. Examples of such un-resettable real-time clocks may be found at http://fortezza-support.com/fortezza.html, which describes the use and applications of Fortezza PCMCIA cards for secure PC use.

While these Prior Art systems have many advantages, there is room for improvement in the art. For example, if the hard drive fails, or the entire computer is lost, all or part of the diary records may be lost. The real-time clock may fail, leading to an inability to time-stamp. In addition, the computer must be carried along if the user is to keep a diary during travel, and the actual computer may be rather expensive.

The forgoing problems may be solved by implementing an Internet or Web diary in which the diary records may be stored at an archive remote from the point of record entry. In such a system, the user's diary is not dependent on local hardware, and moreover, the user may make diary entries from any computer Internet or Web device or other network device (e.g., personal digital assistant, point-of-sale terminal, or other device).

There are numerous Internet or Web services known in the art, which may store data for a user. However, as discussed further in the summary below, these prior art services may allow the user to modify or delete any of their data on request. Thus, these services are unsuitable for a diary in which absolute data security is required. As discussed above, one of the main requirements for a secure diary (or other data storage) is that it should be unalterable by anyone—even the user.

There are also Internet or Web services, which may time-stamp any submitted record. However, most of these services do not store the submission itself, but rather a “hash” or code created from the record submitted. None of these prior art time-stamping services deny the user the capability to delete his/her own records.

Another problem with the personal computer diaries as described in the art is that they either rely on a keyboard for entry, or they make use of voice recognition software to produce voice transcriptions. A traditional keyboard is bulky and restricts the portability of the diary. Miniaturized keyboards are nearly impossible to use for regular typing duty.

Voice recognition software may be used to enter data into a computer device. However, voice recognition applications may be power-intensive such that a portable system relying on voice recognition may have a short battery life. Moreover, voice recognition may require a level of computing power that may not be available on some portable computing devices, cell phones, wireless device and the like. In addition, there may be instances where a user may wish to enter diary or other record data from a telephone or other device, which may not have voice recognition capabilities.

Remote voice recognition capability exists in the art. Reed, U.S. Pat. No. 5,371,901, issued Dec. 6, 1994, entitled “Remote Voice Control System”, incorporated herein by reference, discloses a remote voice transcription system.

Such voice recognition technology or remote human transcriptionist may be used for diary input. However, if the remote voice transcription facility were at the same location as the remote archive where the data may be stored in an encrypted form, then privacy may be compromised, as the remote transcription facility may have access to the source data. For this reason the remote voice transcription facility may, in the preferred embodiment, be independent of the archive.

Yet another problem with personal computer diaries as described in the Prior Art is that the hardware of the diary itself performs any needed encryption functions. This also is a computer drain and, just as for voice recognition, the encryption may be performed remotely. There is often a need in the computer art to encrypt and decrypt files on remote computers.

Again, however, if the remote encryption computer were at the same location as the remote archive, then privacy may be compromised, as the remote archive may be able to decrypt the data and have access to the source data. For this reason, a need remains in the Prior Art for a remote encryption facility independent of the archive. Alternately, a need remains in the art to provide the transcription and encryption facilities co-located, so long as that location was independent of the archive.

### SUMMARY OF THE INVENTION

The increased availability of digital communication over the Internet or Web makes it possible to have a physically separated, central location, (i.e., an archive), where diary entries and signatures may be time-stamped on receipt and securely stored. Actual diary entries may be created, and a digital signature be calculated and appended at many locations and, from such locations, transmitted as a diary record to the archive over the Internet or Web. Even more generally, the time-stamp may be created remotely from the archive; and the signature may be calculated at a location remote from where the diary entry is created, provided that it can be assured that only the user can initiate the signature calculation. Various biometric and other means to assure this are known in the art. Also, the user may direct that data not originating at his or her location, for example a current newspaper story on the web, be signed, time-stamped, and stored at the archive as a diary entry.

To ensure that the user cannot modify or delete a diary entry, once it is sent to the archive, in one embodiment of the present invention, the user and the archive may enter into an agreement that the archive may store the submitted diary records for a fixed period of time, and that the archive may not allow anyone, including the user, to modify or delete these records during this time interval even if the user should ask this to be done. This agreement may be referred to as an agreement for non-rescindable storage for an agreed time interval.

The non-rescindable storage feature of the invention is different from the Prior Art because of the unique requirements of a diary or other secure record storage. There are numerous commercial data archiving facilities known in the Prior Art. However, in such Prior Art storage facilities, if the user desires to withdraw the data, the archive may naturally comply, setting aside questions of normal business expenses. Records are often required by law to be kept for a period of time, but if the government, assuming the role of the user, were to change the law, as it has the power to do, the records could be destroyed.

In contrast, in the present invention the archive agrees with the user to keep the records for a specified time interval and, for that period, not to destroy those records even if the user should ask it to do so. This agreement corresponds in some ways to the purchase by the user of an actual physical diary in the form of a book, with bound pages, suitable for a user to write on.

To ensure privacy, comparable to that available on a personal computer hard drive, it is an aspect of the invention that portions of the records, (e.g., the diary entries), may be encrypted by the user before transmittal to the archive, and decrypted after being retrieved. Thus even the archive may not read those portions of the diary records. Even if the actual diary entries are encrypted, if the digital signature of the unencrypted diary entry is time-stamped, it may be proved that the original unencrypted entry was in existence at the time of the time-stamp.

Of course, the archive may, for an agreed period of time, supply the user on demand with a copy of any of the user's diary records. And the user may, if necessary, decrypt any encrypted portions of the retrieved copy of the records.

Of course, as is standard in the art, access of the user to the archive may be mediated by password, secure socket layer technology, or other means.

The archive may be made very reliable by means standard in the computer industry such as daily backups and secure installations and the like, such that risks of loss of the diary records may be greatly reduced in comparison to the risks attendant to the use of a personal computer diary. There are several approaches to time-stamping the record at the archive or other computing facility, which are known in the art. These approaches may be made more reliable and secure at an archive than by systems relying primarily on a personal computer.

For some diary records, privacy may not be of paramount importance, so any point of access to the Internet or Web may suffice to submit a diary record to the archive without concern that the data processing computer or communications system may be compromised.

Thus it may not be necessary to carry along a personal computer while traveling in order to maintain a secure diary. Moreover, the present invention may be applied to other situations where secure records are required. In such applications, a local computer may not be needed to securely store the diary.

Nonetheless, at relatively little expense, a secure digital signature may be applied, and the data may be encrypted before submission while traveling by, use of, for example, PCMCIA tokens which may be inserted in slots in many computers, and which are currently commercially available.

Since in the present invention it is not necessary to purchase a special personal computer in order to implement the personal computer diary, cost of using such a diary may be lower.

Just as the Internet or Web makes it increasingly possible to archive the computer diary at a location remote from the user, so also it makes it possible to reduce the bulkiness and power requirements of the diary by using remote computers to facilitate diary entry using voice recognition techniques and to encrypt a diary entry using power available to a remote computer. To ensure privacy, these remote computers may need to be independent of the archive computer.

A user may choose to transcribe the non-private portions of the diary entry and then add or change a few words, which may make the entry private. In this case he may trust an encryption party more than any transcription party. Thus it may be useful to keep transcription and encryption parties separate. A similar analysis suggests that a decryption facility may be useful in some cases if it were independent of the other parties.

### BRIEF DESCRIPTION OF THE DRAWINGS

FIG. 1 is a general block diagram of the major functions involved in creating and storing a diary record.

FIG. 2 is a general block diagram of the major functions involved in recovering and reading a copy of a stored diary record.

FIG. 3 is a general block diagram of the major functions involved in providing a third party the ability to authenticate the authorship and time of creation of a diary record.

FIG. 4 is a general block diagram illustrating the use of a remote voice transcription facility to generate text from a user's voice for the user to produce a diary entry for transmission to the archive.

FIG. 5 is a general block diagram illustrating the use of a remote encryption facility to perform some encryption functions, which are useful in a personal computer diary.

FIG. 6 is Block diagram illustrating another embodiment of the present invention.

### DETAILED DESCRIPTION OF THE INVENTION

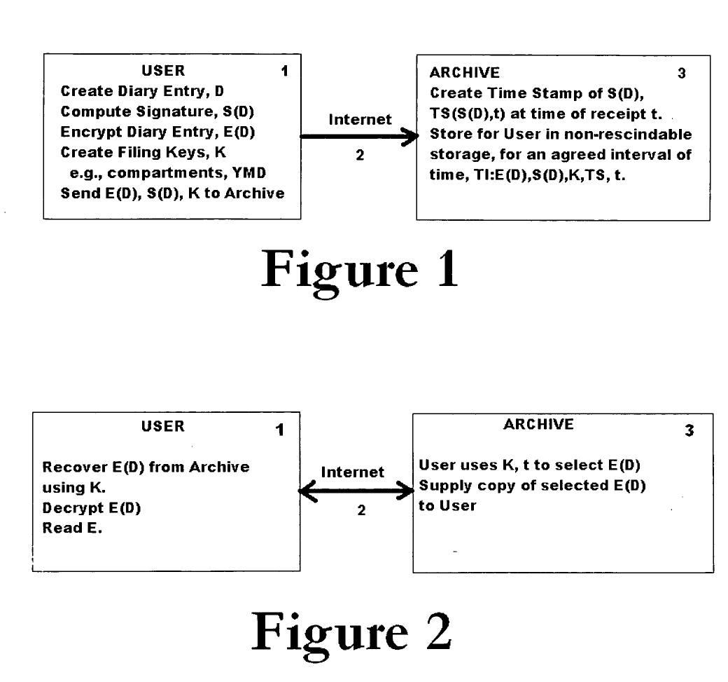

As illustrated in FIG. 1, an Internet or Web diary in accordance with the invention includes an input for the user under the control of the user, (e.g., word-processing software or personal computer diary software), to create a diary entry or original data blocks D. Although disclosed in the present description in the context of a computer diary, the present invention may be applied to other data storage systems where security and authenticity of stored data is required. Such applications include but are not limited to, legal applications (legal testimony, court documents, and the like), accounting applications (storage of accounting data to insure books are not later altered or tampered), medical applications (storing of orders, patient information, and the like) as well as other applications where secure and authenticated data storage is required.

Referring back to FIG. 1, user 1 input further includes an encryption means for computing a digital signature S(D) of diary entry D. Such encryption techniques and means of generating digital signatures may comprise any one of a number of techniques known in the art.

User 1 input may also include a means for encrypting diary entry D to produce an encrypted diary E(D). Again, the type of encryption technique used may comprise any one of a number of known encryption techniques. Software for the encryption capabilities is available, for example, from RSA Inc., of Bedford, Mass. (www rsasecurity.com).

User 1 input may also include a means for creating filing keys K, for diary entry D. Filing keys K (e.g., compartment name or significant words) may comprise a randomly generated or designated filing key K unique to user 1 or assigned by the system. These keys can be useful in retrieving desired data from the archive, even if the data are encrypted. If desired for further privacy the keys themselves could be encrypted. Then they may be retrieved, decrypted, and then used to select the desired diary entries.

Once diary entry D and its related encryption data is generated, user 1 input may send a set of data blocks comprising encrypted diary E(D), digital signature S(D) of diary entry D, and filing keys K, preferably as a single record over communication means 2 to archive 3. Communication means 2 in the preferred embodiment may comprise the Internet or Web or other data link. Such communication means may require that user 1 supply archive 3 with a password or other identification means, to verify the right of user 1 right to store data in the file of user 1 in archive 3.

It should be noted that for the purposes of the present invention, the various data links illustrated in the present invention are illustrated as Internet or Web 2 or other type of network. However, the scope of the present invention should not be interpreted as being limited to such an embodiment. Other data links, including, but not limited to dial-up communication, wireless communication, cellular telephone communication, local and private networks, WiFi and other local wireless networks, bluetooth and satellite communications and the like, may be used for the various communication links in the present invention.

Referring back to FIG. 1, in the preferred embodiment, communication may occur over Internet or Web 2, making use of Secure Sockets Layer technology so that the entire transaction is secure against eavesdropping.

In the preferred embodiment user 1 may make use of public key UPU, of the public key-private key pair of user 1, or some other encryption key of user 1, to compute the encrypted diary E(D), and use private key UPR in computing the digital signature S(D) of diary entry D. As is known in the art, public keys UPU are generally available from certification authorities.

In the preferred embodiment, the word processing or personal computer diary software may reside on a user-owned personal computer or similar computer. Private key UPR may reside securely in a PCMCIA card token which may store private key UPR, calculate the digital signatures, perform the encryption and, when the computer is used alone as a personal computer diary, may time-stamp TS digital signature S(D) of diary entry D using a secure real-time clock in the PCMCIA card. Such PCMCIA cards are available from, for example, Spyrus Inc. of San Jose, Calif. (www.spyrus.com).

User 1 may alternatively send D instead of encrypted diary E(D) to archive 3. Of course, encrypted diary E(D) is preferable for privacy reasons because it ensures that the diary is completely private; neither a hacker on the Internet or Web, nor archive 3 itself may be able to read the diary. It may be useful, however, to be able to send D instead of encrypted diary E(D) for example when privacy is not needed for diary D, or if suitable encryption facilities are not available to user 1, or if encryption takes too much computer time.

One benefit of storing D instead of encrypted diary E(D) is that user 1 may use search facilities at archive 3 to search diary entries directly, without having to decrypt first. Otherwise, user 1 may have to recover such files using filing keys K, and decrypt the encrypted diary E(D) using the decryption key of user 1 (UPR is the preferred embodiment) on the computer of user 1 before searching further. Such a technique could be time consuming. To search all diary entries more completely than possible using only the filing keys K, every record would have to be downloaded as an encrypted diary entry E(D), decrypted in the computer of user 1, and then searched as a decrypted diary entry D.

One case in which encryption facilities may not be available is where user 1 cannot use their personal computer and instead has to use another computer or device. Then it may be useful to be able to download word-processing, encryption or other personal computer software appropriate for creating diary entries from archive 3 or other source. In this case, however, public key UPU of user 1 may not be available. If so, it may be advantageous to send D instead of encrypted diary E(D) to archive 3. Of course, without UPR or equivalent user 1 may not be able to calculate S(D) and hence the archive or similar facility would not be able to calculate the timestamp TS(S(D),t). Time-stamping may have to be done later in a supplementary calculation resulting in a new archived entry. It may be useful to instead calculate the time-stamp over D or E(D) on these occasions. Thus the entry could be time-stamped, but with less assurance that it came from user 1 at that time.

On the other hand, it may be useful for archive 3 to offer the service of providing public key UPU of user 1 on request to user 1 upon login. User 1 may then store diary entry D encrypted on archive 3 and only user 1, later being in possession of private key UPR may decrypt it. Public key UPU of user 1 may also be available from a certification authority on the Internet or Web.

Of course in any of these cases it may be necessary for user 1 to provide some level of identification (e.g., logon and password) in order to submit diary entries or to recover copies of diary entries.

For example, at the level of password only, user 1 may be granted the ability to submit entries but not to recover copies. To recover copies, user 1 may have to be in possession of a PCMCIA card token (or USB “dongle” or the like), which makes use of private key UPR of user 1 in an identification protocol, or successfully passes some other challenge-response test over a secure communication channel.

However, should user 1 have the aforementioned PCMCIA card (or other device or code) available, and should there be a slot on the computer providing access to the downloaded software, it may be possible to perform the full functions available to user 1 on the personal computer of user 1.

Alternatively, the required word processing or personal computer software may be available on the PCMCIA card (or the like) and may be loaded from there into the available computer instead of requiring an Internet or Web download.

In any case, if user 1 is using a general-purpose computer, there is always the risk that software has been installed on that computer to intercept all information entered by user 1 (e.g., a keystroke logging routine, which may be present in some network security systems, computer viruses, or even e-mail worms). Thus, to provide more security, a more secure system may be used, such as the special purpose personal computer diary system invented by the present inventor and previously incorporated by reference.

Archive 3 may use a time-stamping means to create a time-stamp TS of the digital signature S(D) of diary entry D, and the time of receipt t of digital signature S(D) of diary entry D. In the preferred embodiment, archive 3 may use its private key APR of its private key-public key pair to compute time-stamp TS using time of receipt t, from a secure clock maintained by archive 3. Archive 3 private key APR and secure clock are secure against tampering by unauthorized personnel, including user 1. An example of such a time-stamping service is that provided by MediaRegister Inc., of Whippany, N.J. (See www.mediaregister.com). Other secure means of computing time-stamp TS are known in the art, which involve neither private keys nor secure clocks, and these means may also be used within the spirit and scope of the present invention.

One example is the capability offered by Surety Inc., of Herndon, Va. (www.surety.com) involving the use of one-way hash functions to form an unalterable linked list of time-stamp certificates. The following patents, all of which are incorporated herein by reference, are assigned to Surety, Inc. of Herndon Va., or Bell Communications Research, Inc. of Livingston, N.J., and describe various time-stamping capabilities:
Haber et al., U.S. Pat. No. 5,781,629
Haber, et al., U.S. Pat. No. 5,136,647
Haber et al., U.S. Pat. No. Re 34,954
Haber et al., U.S. Pat. No. 5,136,646
Haber et al., U.S. Pat. No. 5,373,561

Another example of a digital signature technique is disclosed in Merkle, U.S. Pat. No. 4,309,569, also incorporated herein by reference.

Referring back to FIG. 1, archive 3 may then store encrypted diary E(D), digital signature S(D) of diary entry D, filing keys K, time-stamp TS, and time of receipt t, for time interval TI, which has been agreed upon in advance between user 1 and archive 3. Preferably the aforementioned elements may be stored as a single record.

The method of determining agreement on time interval TI may preferably be a commercial contractual agreement between user 1 and archive 3. For example, archive 3 may contract to provide ten megabytes of non-rescindable storage for ten years for a fee of $10 or the like.

In other embodiments, archive 3 may agree to provide the non-rescindable storage until further notice in return for personal information about user 1, or in return for having user 1 read banner ads on the web page of archive 3.

At any time before agreed storage time interval TI has passed, in the preferred embodiment, user 1 may agree with archive 3 to continue service for additional time.

User 1 may also agree with archive 3 for archive 3 to permanently erase all or selected user's files after time interval TI has elapsed.

Alternatively, no such agreement may be reached, and user 1 may agree in advance that the files may be released to specified parties, possibly including user 1, if archive 3 so desires, and if the files have not been permanently erased and were available.

It may be agreed in the preferred embodiment that user 1 may download all files before time interval TI and store the records on, for example, a compact disk or on a personal computer diary where they may be stored indefinitely.

During time interval TI, archive 3 may not allow user 1, or any other party, to modify or erase encrypted diary E(D), digital signature S(D) of diary entry D, time-stamp TS and time of receipt t. Archive 3 may, however, allow user 1 to recover encrypted diary E(D), digital signature S(D) of diary entry D, filing keys K, time-stamp TS, and time of receipt t, under password or other identification means, during time interval TI.

In some practical embodiments, known to those skilled in the art, a secret symmetric session key USC of user 1 may actually be used to encrypt and decrypt diary D, which differs for different encrypted diaries E(D). In such an embodiment, it may be useful if secret symmetric session key USC were itself encrypted, preferably with public key UPU of user 1, resulting in an encrypted secret symmetric session key E(USC) stored with encrypted diary E(D).

When encrypted diary E(D) and encrypted secret symmetric session key E(USC) are recovered by user 1, encrypted secret symmetric session key E(USC) may be decrypted using private key UPR, yielding secret symmetric session key USC, which may then be used to decrypt encrypted diary E(D).

Note that in all of these embodiments, the availability of private key, UPR of user 1, may be critical. If user 1 should lose access to this key, for example through a system crash, access to the diary itself may be denied.

Thus, in all embodiments, some backup for private key UPR may be desirable. These may consist of a copy of private key UPR in a secure safe, or, in another embodiment, may require that portions of the key distributed among several trusted entities using shared secret techniques known to those skilled in the art. With some of these techniques, the key may be reconstructed if some minimum number or more of the trusted entities agree to do so. These entities may require proof of the identity of user 1, and thus the right of user 1 to private key UPR. Then, by supplying their portions of private key UPR to user 1, they enable user 1 to reconstruct private key UPR.

FIG. 2 is a general block diagram of the major functions involved in recovering and reading a copy of a stored diary record In one embodiment of a digital diary, as illustrated in FIG. 2, user 1 may request and archive 3 may supply, a copy of several encrypted diary entries E(D) from archive 3. If the filing keys K included dates, then a typical request may result in all encrypted diary entries E(D) with key dates between two dates submitted by user 1.

The key dates may not be necessarily the dates of storage. The key dates may represent dates of earlier diary entries for which the retrieved entry represented annotations or elaborations when submitted later. For example, if on one's 2006 birthday, one compared one's 2006 birthday to one's 2002 birthday, the key may be the date of the 2002 birthday. Searching for the 2002 birthday date between 2002 and 2008 may retrieve the 2006 entry.

Annotations and elaborations may be written and stored by user 1 as encrypted commentary on previous diary entries which were incomplete and were stored unencrypted as D instead of encrypted diary E(D) because of lack of encryption capability at the time D was created. A suitable use of date keys may ensure that the encrypted commentary is retrieved together with the encrypted related material.

Another request may be, for example, for all encrypted diary entries E(D) for which time of receipt t, or a filing key K date lies between two dates input by user 1.

It may not be necessary for user 1 to create filing keys K, as encrypted diary E(D) may usefully be recovered by searching only on time of receipt t.

If filing keys K included a name or a compartment keyword then the request may be for all files with filing keys K including that name or including that compartment keyword. The use, generation, and definition of compartments are discussed in aforementioned Blandford, U.S. Pat. No. 5,347,579, incorporated herein by reference.

For increased security, another embodiment may include the steps of encrypting filing keys K and storing them at archive 3 as encrypted keys E(K). To search using these encrypted keys E(k), user 1 may recover all filing keys K stored between some pair of dates, decrypt them to determine the time of receipt t for the encrypted diary entry E(D) of interest, and recover those encrypted diary entries E(D).

Another embodiment allows user 1 to provide, and archive 3 to store rescindable storage filing keys KR, either encrypted or non encrypted in association with the related diary entry D or encrypted diary E(D). User 1 may modify these rescindable storage filing keys KR as desired to change the compartments and other filing keys which are useful for searching the encrypted diary E(D). Such rescindable storage filing keys KR may be expected to change with time, as, for example, certain topics become more or less related to one another. Of course encrypted diary E(D) and the original filing keys K, may continue to be in non-rescindable storage.

When encrypted diary E(D) is recovered, it may be decrypted and diary entries D displayed and searched using word processing or other personal computer diary software.

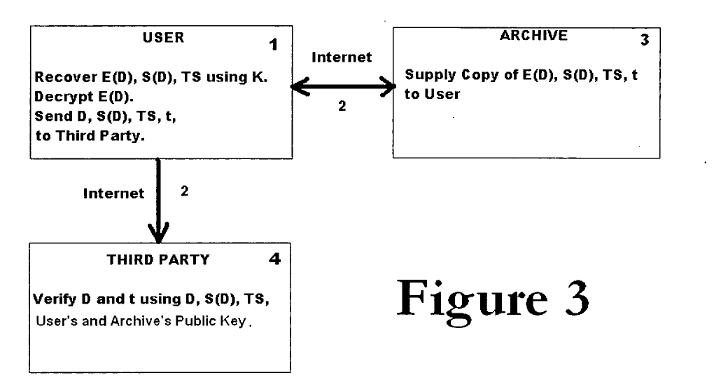

FIG. 3 is a general block diagram of the major functions involved in providing a third party 4 the ability to authenticate the authorship and time of creation of a diary record. As illustrated in FIG. 3, if it is desired at some time to enable a third party 4 to verify that a particular diary entry D was written by user 1 on a specific date, user 1 may request encrypted diary E(D), digital signature S(D) of diary entry D, time-stamp TS, and time of receipt t, from archive 3. Then user 1 may decrypt encrypted diary E(D) to determine diary entries D, and then send diary entries D, digital signature S(D) of diary entry D, time-stamp TS, and time of receipt t, to third party 4. It may also be necessary for verification that third party 4 have, in the preferred embodiment, the public keys UPU of user 1 and of archive 3. If the time-stamp had been computed over E(D) instead of S(D) then it may also be necessary to supply the third party with the secret symmetric session key USC, generated during encryption, as well as E(D).

Both public keys UPU of user 1 and archive 3 keys may be available from a certification authority, or they may be obtained directly from user 1 and from archive 3. With the public keys UPU of user 1 and archive 3, third party 8 may verify that user 1 created diary D, and that diary D was stored at archive 3 at time of receipt t. Software to carry out such verifications is available from, for example, RSA Inc. of Bedford, Mass. (www.rsasecurity.com). If alternate time-stamping methods are used, other time-stamping data may be required from, e.g., Surety Inc. of Herndon Va. (www.surety.com).

It may occur before time interval TI that the encryption techniques used by user 1 to create encrypted diary E(D) became insecure so that there may be some risk that archive 3 may be able to decrypt encrypted diary E(D) and to read diary D. To prevent such a scenario, it may not be suitable for user 1 to recover diary D and re-encrypt it with an improved algorithm and then resend it to archive 3, because user 1 may have substituted some other diary D′ for diary D, and archive 3 may have no way of knowing.

One alternative is for user 1 to supply archive 3 with the public key UPU of a public-key private key pair that user 1 has determined. Then archive 3 may make use of public key UPU to super-encrypt user data blocks. User 1 may remove this super-encryption after retrieval. Of course, it is possible that archive 3 has made a copy of the original encrypted diary E(D) and may decrypt that when decryption technology became more advanced. The only security against this possibility may be to trust in archive 3.

Should it appear possible that time-stamp TS may, after initial storage, become insecure, it is well known in the art that if time-stamp TS may be re-time-stamped with a more secure algorithm, then time-stamp TS may remain valid up to the time when the improved algorithm becomes insecure, thus extending its interval of validity. This re-time-stamping may, of course, be performed by archive 3 without the assistance of user 1.

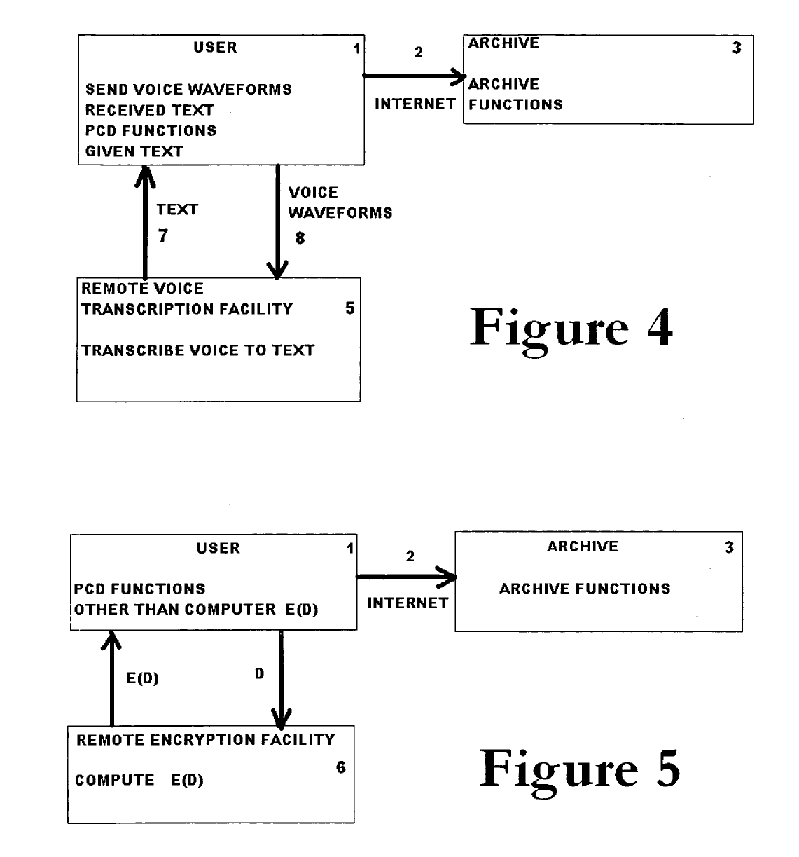

FIG. 4 is a general block diagram illustrating the use of a remote voice transcription facility 5 to generate text from a the voice of user 1 (or other voice supplied by user 1) for user 1 to produce a diary entry for transmission to archive 3. As illustrated in FIG. 4, input to diary entry D may begin by user 1 speaking into a microphone connected to personal computer diary. In a preferred embodiment, which makes use of voice recognition, the PCD may have the appearance, and much of the functionality, of a cellphone, or may comprise a software package or hardware integrated into a cellular telephone or other existing communication device (e.g., telephone, PDA, Blackberry, or the like). Voice waveforms 8 embodying diary entry D may be transmitted to the remote voice transcription facility 3, using one of several communication means 2, such as the Internet or Web or the like.

Remote voice transcription facility 5 may then create a preliminary version of diary entry D in text form 7 and transmit it back to the user 1. Using the PCD data entry devices, and perhaps additional voice interactions mediated by the remote voice transcription facility 5, user 1 may edit raw voice diary entry into the final form of diary entry D and transmit it to archive 3.

In the preferred embodiment, transcription is provided from voice-to-text using any one of a number of known voice recognition systems such as the DRAGON or IBM voice recognition software. Alternately, transcription may be manually performed (e.g., by a human operator) in remote voice transcription facility 5.

Referring back to FIG. 4, in some embodiments it may be useful to send the preliminary version of diary entry D in text form 7 directly to archive 3 without further editing. This may be accomplished by user 1 instructing remote voice transcription facility 5 to forward the text directly to archive 3. Archive 3 may ensure that the storage from a third party is authorized by requiring user 1 to certify in advance that submissions from remote voice transcription facility 3 are to be accepted for diary entry D of user 1. Alternately, user 1 may supply remote voice transcription facility 5 with a password for the account of user 1 at archive 3.

FIG. 5 is a general block diagram illustrating the use of a remote encryption facility 6 to perform some encryption functions, which are useful in a personal computer diary. In the embodiment illustrated in FIG. 5, should user 1 desire to encrypt diary D (perhaps after the preliminary version of diary D is returned from remote voice transcription facility 5 and has been edited into the final version of diary D), diary D may be sent by user 1 to the remote encryption facility 6, where encrypted diary E(D) is computed. In the preferred embodiment, encrypted diary E(D) may be computed using public key UPU of user 1 as obtained from a certificate authority (CA). Then, encrypted diary E(D) may be transmitted back to the user 1 where, after further processing if necessary, it may be sent to archive 3.

Again, just as for the remote voice transcription facility 5 of FIG. 4, it may be useful to send encrypted diary E(D) directly to archive 3 without returning it to user 1.

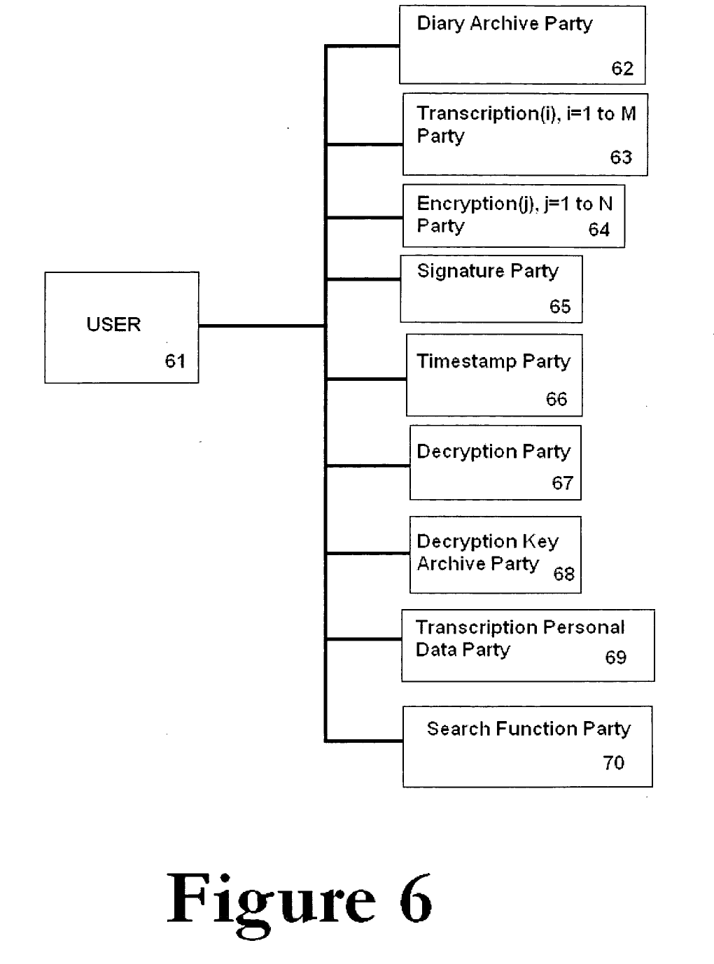

FIG. 6 is Block diagram illustrating a combined embodiment of the present invention, illustrating how the various parties of FIGS. 1-5, as well as additional parties, may interact to produce a secure on-line diary entry D.

If the personal diary D at diary archive party 3 is encrypted, user 1 may deny themselves access to the non-rescindable diary E(D) by, on purpose, losing access to the decryption key. This may tend to defeat the purpose of a personal diary, however.

To instead provide assured access, the decryption key may be contracted to be non-rescindably stored at a decryption key archive party 68, but with assured access by user 1. Assured access to the decryption key may be defined as the ability of user 1 to access the decryption key after an extensive period in which, for example, the diary system had been ignored and, personal records of decryption keys had been destroyed, either willfully or by accident, by the user or by others.

In one embodiment, user 1 may be contractually required to contract with decryption key archive party 68 for non-rescindable storage of the decryption key at the same time that user 1 contracted with diary archive 3 for non-rescindable storage. Naturally, key storage may 68 ideally, but not necessarily, be for the same time interval TI as the diary storage.

Of course decryption key archive party 68 may have access to the decryption key and so may decrypt user 1's encrypted diary. However, in general, decryption key archive party 68 may not have access to diary D of user 1, encrypted or unencrypted, stored at diary archive 3.

Exercise of assured access may require personal data described by the phrase, well known to those skilled in the art, of “something you are”.

The triumvirate, to those skilled in the art includes “Something you know”, e.g., a password, and “Something you have” e.g., a smart card. One can on-purpose lose a password or a smart card; but one cannot lose or change “Something you are.”

Decryption key archive party 68 may require verification of “Something you are” data as a characteristic of user 1 by a verification party, trusted by decryption key archive party 68. One may refer to these verified data as “verified personal data”.

Verified personal data may include biometric data such as fingerprints, retinal patterns, or finger proportions. It may also include, for example, such verifiable data as home addresses, names of employers, or even an e-mail address of user 1. Of course, the required data may have to be on record at decryption key archive party 68, and this may be a prerequisite for use of decryption key archive party 68.

It may also be desirable for user 1 to be contractually required to contract for assured access to diary archive 3. Otherwise, user 1 may, on purpose, permanently lose access to his diary by forgetting a password, whether or not diary D was encrypted.

Of course it is common for organizations storing data (e.g., web pages,) for individuals to provide assured access. However this service is not in combination with non-rescindable data. Correspondingly, the motivation is different. The motivation is to restore access after a password has been accidentally lost or forgotten, not after it has been purposely lost or forgotten. Hence access is often assured by “something you know” or “something you have” on the assumption that these items will not be purposely lost or forgotten. In the present case the motivation is also to ensure that a digital diary archive has properties more similar to those of a bound personal diary. Hence assured access to the decryption key in the decryption key archive party 68, and to the archive 3, may need to be provided by verified personal data comprising verified “something you are” data which cannot be lost or forgotten.

Some input data to diary D may need to be transcribed before being sent to diary archive 3. For example, voice data may need to be transcribed to ASCII text. Alternatively, for example, data may need to be transformed from Microsoft Word format to ASCII. Transcription party 5 may perform such tasks. Transcription party 5 may transcribe input data and may return transcribed data to user 1 for quality control, if desired.

It may be desirable for there to be several transcription parties 5 (e.g., parties(i), where i=1 to M), and for them to be independent of each other and of the diary archive party 3. Otherwise the privacy of diary D may be more easily compromised.

Since, for privacy reasons, there may be multiple transcription parties, it may be useful for there to be a transcription program personal data party 69, which may store personal data useful to facilitate transcription. In the case of transcription from speech to ASCII, such data may include definitions of idiosyncratic terms, background information for the typical diary entry, names of persons and places which are commonly referred to, and the like. Also, recordings of user 1 speaking frequently occurring phrases may be useful. In the case that the transcription is of voice and by voice-recognition software, the special data personal data files required for this software may also be available at transcription program personal data party 69. Some of these data may be sensitive and need to be protected by password.

Similarly, for privacy reasons, there may be multiple encryption parties 6.

As noted previously, there may also be available on the web (or on user 1's lap-top) a signature party 65, and a time-stamping party 66. Access to signature party 65 may need to be carefully controlled, otherwise entities other than user 1 may impersonate user 1. For this reason it is not envisioned that there may be more than one signature party 65, although, in principle, there may be. Decryption parties 67 should be similarly controlled. In the preferred embodiment, decryption may be performed in user 1's personal computer diary.

In general, for privacy reasons, it is desirable that there be multiple transcription 6 and encryption 6 parties so that no single party may illicitly retain a complete diary D.

For reliability, but not for privacy, it may be useful for there to be multiple signature parties 65, time-stamping parties 66, decryption parties 67, decryption key archive parties 68, and transcription personal data archive parties 69 It may be desirable for security and privacy that all of these parties be independent of each other.

A typical scenario of creating a web diary entry may be as follows: User 1 is on a cell phone, connects to one of several of his transcription services 5 and dictates a diary entry. He also sends the web location of his transcription program personal data party 69. Transcription party 5 accesses that personal data and uses it to determine ASCII text. The text is transmitted back to user 1. He edits the text as needed, including determining key words, and transmits the text and key words (or their hash) to his digital signature party 65, which requires a user password, or other validation, before it may execute a digital signature. After it is digitally signed, it is forwarded to a time-stamping party 66, which returns the time-stamped data to user 1. User 1 then sends the original data and the digitally signed and time-stamped data to one of his encryption parties 6 (j), j=1 to N, which then forwards the encrypted ASCII data to his personal diary at his diary archive party 3 for archiving.

In the preferred embodiment the transcription party 5 and encryption party 6 are randomly selected in order to minimize the risk of privacy violations.

When user 1 wishes to read his diary D, he is more likely to be sitting at a laptop. In that case he may recover the encrypted file keys from archive 3, decrypt the file keys on the laptop using the decryption key, use the file keys to determine which diary data to recover, recover the appropriate diary data D from archive 3, decrypt them and read. Of course, as noted previously, the data in archive 3 may not be encrypted, in which case the search for data of interest may be performed at archive 3. Alternately, decryption party 67 may perform the decryption, as illustrated in FIG. 6. Of course, as noted above, use of a decryption party 67 may also risk privacy.

In addition to all the other functions and parties described in FIG. 6 being separate from archive 3 and from user 1, a search function party 62 may be provided, but not necessarily on the system of user 1. The system of user 1 might not be powerful enough to hold all the text and/or to search. Data may need to be decrypted before being searched. It may be most efficient for the search to be at the same party where data is decrypted (e.g., decryption party 67), since user 1 presumably already trusts decryption party 67.

But it is possible that decryption party 67 may not be general purpose enough to search, as well as decrypt, or user 1 may not want decryption party 67 to know what user 1 is searching for. So, there may be reasons for keeping searching party 62 and decryption party 67 separate. Of course, user 1 should be able to trust search party 62 also.

Once after a search is complete, search party 62 may send the results back to user 1. Small parts of diary D, produced in formats such as Google-type reports, might be sent back, and user 1 may then decide which full parts of diary D he wants transmitted to him.

While the preferred embodiment and various alternative embodiments of the invention have been disclosed and described in detail herein, it may be apparent to those skilled in the art that various changes in form and detail may be made therein without departing from the spirit and scope thereof.

1. A system for archiving data blocks comprising:
a user data processing means for a user to form one or more data blocks;
transmission means, coupled to the user data processing means, for transmitting said data blocks from the user data processing means; and
remote archive storage means, coupled to the transmission means, for receiving and storing the one or more data blocks, said remote archive storage means preventing anyone, including the user, from modifying or deleting said one or more data blocks stored at said remote archive storage means to provide non-rescindable storage of said data blocks for at least an initial time period.

2. The system of claim 1, wherein the user negotiates the initial time period with the remote archive storage means to reach agreement on an initial time period for non-rescindable storage of said one or more data blocks.

3. The system of claim 1, further comprising:
means for retrieving, from the remote archive storage means to the user, a copy of the one or more data blocks.

4. The system of claim 1, further comprising:
digital signature generating means, coupled to said user data processing means, for computing for the user, a secure digital signature data block comprising a secure digital signature of the one or more data blocks, and appending the digital signature data block to the one or more data blocks.

5. The system of claim 4, wherein the digital signature generating means comprises a digital signature generating party independent of the user data processing means, and coupled to the user data processing means via the transmission means.

6. The system of claim 1, further comprising:
secure time-stamping means coupled to the user data processing means and the remote archive storage means for receiving the one or more data blocks, time-stamping the one or more data blocks on receipt, and storing said time-stamp as an additional non-rescindable data block with the one or more data blocks in the remote archive storage means.

7. The system of claim 6, wherein the secure time-stamping means comprises a secure time-stamping party, independent of the user data processing means and the remote archive storage means, coupled to the user data processing means and the remote archive storage means by the transmission means.

8. The system of claim 1, further comprising:
encryption means, coupled to the user data input means and the remote archive storage means, for encrypting the one or more data blocks to create one or more encrypted data blocks, and transmitting said one or more encrypted data blocks to remote archive storage means in place of said one or more data blocks.

9. The system of claim 8, wherein the encryption means comprises an encryption party, independent of the user data processing means and the remote archive storage means, coupled to the user data processing means and the remote archive storage means via the transmission means.

10. The system of claim 1, further comprising:
filing key generating means, coupled to said user data input means and said remote archive storage means, for generating filing keys from said one or more data blocks.

11. The system of claim 10, wherein said filing key generating means comprises an independent filing key generating party, independent of the user data processing means and the remote archive storage means, coupled to the user data processing means and the remote archive storage means via the transmission means.

12. The system of claim 1, further comprising:
search means to search stored filing keys at said remote archive storage means to select at least one of the one or more data blocks for retrieval of copies of the at least one of the one or more data blocks.

13. The system of claim 12, wherein said search means comprises an independent search party, independent of the user data processing means and the remote archive storage means, coupled to the user data processing means and the remote archive storage means via the transmission means.

14. The system of claim 1, further comprising:
encryption means for encrypting the one or more data blocks to produce one or more encrypted data blocks such that the remote archive storage means may not decrypt the one or more encrypted data blocks but that the user may decrypt copies of the one or more encrypted data blocks.

15. The system of claim 14, wherein said encryption means comprises an independent encryption party, independent of the user data processing means and the remote archive storage means, coupled to the user data processing means and the remote archive storage means via the transmission means.

16. The system of claim 1, further comprising:
voice waveform data input means, coupled to said user data processing means, for receiving a user's voice and creating voice waveform data; and
voice recognition and transcription means, coupled to said user data processing means and said remote archive storage means, for generating one or more text data blocks from said voice waveform data transmission for storage in the remote archive storage means.

17. The system of claim 16, wherein said voice recognition means comprises an independent voice recognition and transcription party, independent of the user data processing means and the remote archive storage means, coupled to the user data processing means and the remote archive storage means via the transmission means.

18. The system of claim 2, further comprising:
digital signature generating means, coupled to said user data processing means, for computing for the user, a secure digital signature data block comprising a secure digital signature of the one or more data blocks, and appending the digital signature data block to the one or more data blocks.

19. The system of claim 2, further comprising:
secure time-stamping means coupled to the user data processing means and the remote archive storage means for receiving the one or more data blocks, time-stamping, the one or more data blocks on receipt, and storing said time-stamp as an additional non-rescindable data block with the one or more data blocks in the remote archive storage means.

20. The system of claim 18, further comprising:
secure time-stamping means coupled to the user data processing means and the remote archive storage means for receiving the one or more data blocks, time-stamping the one or more data blocks on receipt, and storing said time-stamp as an additional non-rescindable data block with the one or more data blocks in the remote archive storage means.

21. The system of claim 2, further comprising:
encryption means, coupled to the user data input means and the remote archive storage means, for encrypting the one or more data blocks to create one or more encrypted data blocks, and transmitting said one or more encrypted data blocks to remote archive storage means in place of said one or more data blocks.

22. The system of claim 20, further comprising:
encryption means, coupled to the user data input means and the remote archive storage means, for encrypting the one or more data blocks to create one or more encrypted data blocks, and transmitting said one or more encrypted data blocks to remote archive storage means in place of said one or more data blocks.

23. The system of claim 2, further comprising:
filing key generating means, coupled to said user data input means and said remote archive storage means, for generating filing keys from said one or more data blocks.

24. The system of claim 22, further comprising:
filing key generating means, coupled to said user data input means and said remote archive storage means, for generating filing keys from said one or more data blocks.

25. The system of claim 2, further comprising:
search means to search stored filing keys at said remote archive storage means to select at least one of the one or more data blocks for retrieval of copies of the at least one of the one or more data blocks.

26. The system of claim 24, further comprising:
search means to search stored filing keys at said remote archive storage means to select at least one of the one or more data blocks for retrieval of copies of the at least one of the one or more data blocks.

27. The system of claim 2, further comprising:
encryption means for encrypting the one or more data blocks to produce one or more encrypted data blocks such that the remote archive storage means may not decrypt the one or more encrypted data blocks but that the user may decrypt copies of the one or more encrypted data blocks.

28. The system of claim 20, further comprising:
encryption means for encrypting the one or more data blocks to produce one or more encrypted data blocks such that the remote archive storage means may not decrypt the one or more encrypted data blocks but that the user may decrypt copies of the one or more encrypted data blocks.

29. The system of claim 2, further comprising:
voice waveform data input means, coupled to said user data processing means, for receiving a user's voice and creating voice waveform data; and
voice recognition and transcription means, coupled to said user data processing means and said remote archive storage means, for generating one or more text data blocks from said voice waveform data transmission for storage in the remote archive storage means.

30. The system of claim 28, further comprising:
voice waveform data input means, coupled to said user data processing means, for receiving a user's voice and creating voice waveform data; and
voice recognition and transcription means, coupled to said user data processing means and said remote archive storage means, for generating one or more text data blocks from said voice waveform data transmission for storage in the remote archive storage means.

31. The system of claim 2, further comprising decryption means, coupled to the user data input means and the archive storage means, for decrypting the one or more encrypted data blocks to create one or more decrypted data blocks, and transmitting said one or more decrypted data blocks to the user data processing means.

32. A method for archiving data blocks comprising the steps of:
forming, in a user data input device, one or more data blocks,
transmitting the data blocks from the user using a transmission network,
archiving the one or more data blocks in a remote archive storage, and
preventing anyone, including the user, from modifying or deleting the one or more data blocks stored at the remote archive storage to provide non-rescindable storage of the data blocks for at least an initial time period.

33. The method of claim 32, further comprising the step of negotiating, between the user and the remote archive storage an initial time period to reach agreement on an initial time period for non-rescindable storage of the one or more data blocks.

34. The method of claim 32, further comprising the step of retrieving, from the remote archive storage to the user, a copy of the one or more data blocks.

35. The method of claim 32, further comprising the steps of:
computing, in an encryption data processor coupled to the user data input device, a secure digital signature data block comprising a secure digital signature of the one or more data blocks, and
appending the digital signature data block to the one or more data blocks.

36. The method of claim 35, wherein the step comprising a secure digital signature data block comprises the step of computing the digital signature in a digital signature generating party independent of the user data input device, and coupled to the user data input device via the transmission network.

37. The method of claim 32, further comprising the steps of:
time-stamping in a secure time-stamping device coupled to the user data input device and the remote archive storage, the one or more data blocks upon receipt, and
storing the time-stamp as an additional non-rescindable data block with the one or more data blocks in the remote archive storage.

38. The method of claim 37, wherein the step of time-stamping comprises the step of time-stamping in a secure time-stamping party independent of the user data input device and the remote archive storage and coupled to the user data input device and the remote archive storage by the transmission network.

39. The method of claim 32, further comprising the steps of:
encrypting, in an encryption device coupled to the user data input device and the remote archive storage, the one or more data blocks to create one or more encrypted data blocks, and
transmitting the one or more encrypted data blocks to remote archive storage in place of the one or more data blocks.

40. The method of claim 39, wherein the step of encrypting comprises the step of encrypting in an encryption party independent of the user data input device and the remote archive storage and coupled to the user data input device and the remote archive storage via the transmission network.

41. The method of claim 32, further comprising the step of generating, in a filing key generator coupled to the user data input and the remote archive storage, filing keys from the one or more data blocks.

42. The method of claim 41, wherein the step of generating filing keys comprises the step of generating filing keys in an independent filing key generating party independent of the user data input device and the remote archive storage and coupled to the user data input device and the remote archive storage via the transmission network.

43. The method of claim 32, further comprising the step of searching stored filing keys at the remote archive storage to select at least one of the one or more data blocks for retrieval of copies of the at least one of the one or more data blocks.

44. The method of claim 43, wherein the step of searching comprises the step of searching in an independent search party independent of the user data input device and the remote archive storage and coupled to the user data input device and the remote archive storage via the transmission network.

45. The method of claim 32, further comprising the step of encrypting, in an encryption device, the one or more data blocks to produce one or more encrypted data blocks such that the remote archive storage may not decrypt the one or more encrypted data blocks but that the user may decrypt copies of the one or more encrypted data blocks.

46. The method of claim 45, wherein the step of encrypting comprises the step of encrypting in an independent encryption party independent of the user data input device and the remote archive storage and coupled to the user data input device and the remote archive storage via the transmission network.

47. The method of claim 32, further comprising the steps of:
inputting in a voice waveform data input device coupled to the user data input device, a user's voice and creating voice waveform data, and
transcribing in a voice recognition and transcription device coupled to the user data input device and the remote archive storage, the voice waveform data to create text data blocks from the voice waveform data received from the user data input device for storage in the remote archive storage.

48. The method of claim 47, wherein the step of transcribing the voice waveform data comprises the step of transcribing the voice waveform data in an independent voice recognition and transcription party independent of the user data input device and the remote archive storage and coupled to the user data input device and the remote archive storage via the transmission network.

49. The method of claim 33, further comprising the steps of:
computing, in an encryption data processor coupled to the user data input device, a secure digital signature data block comprising a secure digital signature of the one or more data blocks, and
appending the digital signature data block to the one or more data blocks.

50. The method of claim 49, wherein the step computing a secure digital signature data block comprises the step of computing the digital signature in a digital signature generating party independent of the user data input device and coupled to the user data input device via the transmission network.

51. The method of claim 49, further comprising the steps of:
time-stamping in a secure time-stamping device coupled to the user data input device and the remote archive storage, the one or more data blocks upon receipt; and
storing the time-stamp as an additional non-rescindable data block with the one or more data blocks in the remote archive storage.

52. The method of claim 51, wherein the step of time-stamping comprises the step of time-stamping in a secure time-stamping party independent of the user data input device and the remote archive storage and coupled to the user data input device and the remote archive storage by the transmission network.

53. The method of claim 51, further comprising the steps of:
encrypting, in an encryption device coupled to the user data input device and the remote archive storage, the one or more data blocks to create one or more encrypted data blocks, and
transmitting the one or more encrypted data blocks to remote archive storage in place of the one or more data blocks.

54. The method of claim 53, wherein the step of encrypting comprises the step of encrypting in an encryption party independent of the user data input device and the remote archive storage and coupled to the user data input device and the remote archive storage via the transmission network.

55. The method of claim 53, further comprising the step of generating, in a filing key generator coupled to the user data input and the remote archive storage, filing keys from the one or more data blocks.

56. The method of claim 55, wherein the step of generating filing keys comprises the step of generating filing keys in an independent filing key generating party independent of the user data input device and the remote archive storage and coupled to the user data input device and the remote archive storage via the transmission network.

57. The method of claim 55, wherein the step of searching comprises the step of searching in an independent search party independent of the user data input device and the remote archive storage and coupled to the user data input device and the remote archive storage via the transmission network.

58. The method of claim 47, wherein the step of searching comprises the step of searching in an independent search party independent of the user data input device and the remote archive storage and coupled to the user data input device and the remote archive storage via the transmission network.

59. The method of claim 51, further comprising the step of encrypting, in an encryption device, the one or more data blocks to produce one or more encrypted data blocks such that the remote archive storage may not decrypt the one or more encrypted data blocks but that the user may decrypt copies of the one or more encrypted data blocks.

60. The method of claim 59, wherein the step of encrypting comprises the step of encrypting in an independent encryption party independent of the user data input device and the remote archive storage and coupled to the user data input device and the remote archive storage via the transmission network.

61. The method of claim 59 further comprising the steps of:
inputting in a voice waveform data input device coupled to the user data input device, a user's voice and creating voice waveform data, and
transcribing in a voice recognition and transcription device coupled to the user data input device and the remote archive storage, the voice waveform data to create text data blocks from the voice waveform data received from the user data input device for storage in the remote archive storage.

62. The method of claim 61, wherein the step of transcribing the voice waveform data comprises the step of transcribing the voice waveform data in an independent voice recognition and transcription party independent of the user data input device and the remote archive storage and coupled to the user data input device and the remote archive storage via the transmission network.

63. A system for decrypting encrypted diary entry data stored over a network, comprising:
archive storage means, for storing one or more encrypted data blocks created by a user, said remote archive storage means preventing anyone, including the user, from modifying or deleting said one or more data blocks stored at said remote archive storage means to provide non-rescindable storage of said data blocks for at least an initial time period;
transmission means, coupled to the user data processing means, for transmitting said data blocks from the user data processing means;
a user data processing means, coupled to the transmission means for a user to retrieve one or more data blocks from the archive means through the transmission means; and
decryption means, coupled to the user data processing means and the archive storage means, for decrypting the one or more encrypted data blocks to create one or more decrypted data blocks, and transmitting said one or more decrypted data blocks to the user data processing means.

64. The system of claim 63, wherein the decryption means comprises an decryption party, independent of the user data processing means and the remote archive storage means, coupled to the user data processing means and the remote archive storage means via the transmission means.

65. The system of claim 63, further comprising decryption keys for said decryption means, said keys being non-rescindably stored in a non-rescindable key store.

66. The decryption system of claim 65, further comprising user assured access to said decryption keys in said non-rescindable store.

67. The decryption system of claim 66, further comprising a means for requiring verified personal data of the user by said non-rescindable store in order for said user to have assured access to the decryption keys.

68. The decryption system of claim 65, wherein said non-rescindable store comprises an independent decryption key non-rescindable archive party.

69. The system of claim 3, said archive providing assured access to said means for retrieving data.

70. The system of claim 69, wherein said archive requires verified personal data from said user for providing said assured access.

71. A user device for producing a secure archival personal diary comprising:
a digital processor for receiving user input and outputting one or more data blocks, said digital processor including means for allowing a user to select one or more remotely located data processors for performing at least two of a plurality of data processing functions on at least one of the one or more data blocks, the plurality of data processing functions including two or more of transcribing data blocks, digitally signing data blocks, time-stamping data blocks, encrypting data blocks, decrypting data blocks, storing data blocks in non-rescindable storage, and searching data blocks; and
transmission means, coupled to the digital processor for transmitting said data blocks from the digital processor to at least one or more remotely located data processors along with user commands to the one or more remotely located data processor to perform at least one of the plurality of data processing functions.

72. The user device of claim 71, wherein the user commands comprise a command to a remote archive storage to receive and store the one or more data blocks, the remote archive storage preventing anyone, including the user, from modifying or deleting the one or more data blocks stored at the remote archive storage to provide non-rescindable storage of the data blocks for at least an initial time period.

73. The user device of claim 71, wherein the user commands further negotiate an initial time period with the remote archive storage to reach agreement on an initial time period for non-rescindable storage of the one or more data blocks.

74. The user device of claim 71, wherein the user commands comprise a command to a remote digital signature generator for computing for the user, a secure digital signature data block comprising a secure digital signature of the one or more data blocks, and appending the digital signature data block to the one or more data blocks.

75. The user device of claim 71, wherein the user commands comprise a command to a remote secure time-stamping processor to instruct the remote secure time-stamping processor to receive the one or more data blocks, time-stamp the one or more data blocks on receipt, and store the time-stamp as an additional non-rescindable data block with the one or more data blocks.

76. The user device of claim 71, wherein the user commands comprise a command to a remote encryption processor to instruct the remote encryption processor to encrypt the one or more data blocks to create one or more encrypted data blocks, and transmitting the one or more encrypted data blocks to remote archive storage in place of the one or more data blocks.

77. The user device of claim 71, wherein the user commands comprise a command to a remote filing key generating processor to instruct the remote filing key generating processor to generate filing keys from the one or more data blocks.

78. The user device of claim 71, wherein the user commands comprise a command to a remote search processor to instruct the remote search processor to search stored filing keys to select at least one of the one or more data blocks for retrieval of copies of the at least one of the one or more data blocks.

79. The user device of claim 71, wherein the user commands comprise a command to a remote encryption processor for encrypting the one or more data blocks to produce one or more encrypted data blocks such that a remote archive storage may not decrypt the one or more encrypted data blocks but that the user may decrypt copies of the one or more encrypted data blocks.

80. The user device of claim 71, wherein the user device further includes a voice waveform data input processor for receiving a user's voice and creating voice waveform data,
wherein the user commands comprise a command to a remote voice recognition and transcription processor to instruct the remote voice recognition and transcription processor to generate one or more text data blocks from the voice waveform data transmission for storage in the remote archive storage processor.

81. The user device of claim 71, wherein the said two of a plurality of data processing functions includes storing data blocks in non-rescindable storage.

82. A user device for producing a secure archival personal diary comprising:
a tamper-proof permanent storage device,
a digital processor for receiving user input and outputting one or more data blocks, said digital processor including means for allowing a user to select one or more remotely located data processors for performing at least one of a plurality of data processing functions on at least one of the one or more data blocks, the plurality of data processing functions including one or more of transcribing data blocks, digitally signing data blocks, time-stamping data blocks, encrypting data blocks, decrypting data blocks, storing data blocks in non-rescindable storage, and searching data blocks; and
transmission means, coupled to the digital processor for transmitting said data blocks from the digital processor to at least one or more remotely located data processors along with user commands to the one or more remotely located data processors to perform at least one of the plurality of data processing functions, and for receiving data blocks from the one or more remotely located data processors in response to the user commands to perform at least one of the plurality of data processing functions, and
means for said user device digital processor to transmit data-blocks to the tamper-proof permanent data storage device for storage.
